(19) United States
(12) Patent Application Publication
(10) Pub. No.: US 2004/0125151 A1
(43) Pub. Date: Jul. 1, 2004

(54) Black hole flight simulator

(75) Inventor: Andrew J.S. Hamilton, Boulder, CO (US)

Correspondence Address: PATTON BOGGS, 1660 LINCOLN ST, SUITE 2050, DENVER, CO, 80264, US

(73) Assignee: The Regents Of The University of Colorado, a body corporate, Boulder, CO (US)

(21) Appl. No.: 10/656,620

(22) Filed: Sep. 5, 2003

Related U.S. Application Data
(60) Provisional application No. 60/408,657, filed on Sep. 6, 2002.

(51) Int. Cl. G09G 5/00

(52) U.S. Cl. 345/848

(57) ABSTRACT

Black hole flight simulator software, which simulates interactively the visual experience of flying around, inside, or through a black hole. A black hole flight simulator includes: a memory for storing information for generating a relativistically correct scene depicting a visual experience selected from the group consisting of: a view of a black hole as it is being approached; a view from the inside of a black hole; a view as a black hole is being entered; a view as a black hole is being exited; and a view from a wormhole or white hole or other piece of spacetime that may be attached to a black hole; a processor communicating with the memory for generating electronic signals representing the scene; and a display communicating with the processor for displaying the scene. There is also an input device for changing the simulated position, for changing the field of view of the scene, and for changing the direction of view.

### RELATED APPLICATIONS

This application claims priority to U.S. Provisional Application No. 60/408,657 filed Sep. 6, 2002.

### BACKGROUND OF THE INVENTION

1. Field of the Invention

The invention in general relates to simulation software, particularly such software that is run on a flight simulator.

2. Statement of the Problem

Only a few decades ago, black holes were considered to be a scientific fantasy. Now they are well established as natural objects in our universe. Scientists have learned much about the nature of black holes, both observationally and theoretically. Because they “devour” everything that wanders into them like a cosmic whirlpool, the sheer magnitude of their physical parameters, and the “doomsday” connotations that have become associated with them, they have become objects of fascination not just for scientists, but for writers, philosophers, poets and many lay persons. In particular, they are often depicted in visual and other simulations in movies, videos, etc. However, such simulations are liable to be created by people unfamiliar with black holes, and may be misleading or wrong. For example, in a television feature which was otherwise a wonderful show with beautiful graphics, a black hole simulation broadcast on the Discovery Channel on 12 Oct. 1997 depicted a black hole as the universe concentrating into an ever-diminishing patch of the sky, which finally disappears altogether as the viewer passes into the horizon. Such depictions of black holes are misleading and serve to hinder public understanding of black holes. Unfortunately, black holes are difficult to understand, even by accomplished scientists; thus, videographers and others not skilled in the scientific arts do not have a ready source of correct simulations of black holes. Since most high quality filmmakers prefer to have scientifically correct simulations in their productions, it would be highly desirable to have a ready source available showing the correct behavior of a black hole. Such a ready source of correct black hole simulation would also be highly appreciated by educators.

### SUMMARY OF THE INVENTION

The present invention advances the art and helps to overcome the aforementioned problems by providing a simulation of a black hole that corresponds closely to accepted scientific understanding.

The invention provides a black hole flight simulator comprising: a memory for storing information for generating a general relativistically correct scene depicting a visual experience selected from the group consisting of: a view of a black hole from outside the black hole; a view from the inside of a black hole; a view as a black hole is being entered; a view as a black hole is being exited; and a view from a wormhole or white hole or other piece of spacetime that may be attached to a black hole; a processor communicating with the memory for generating electronic signals representing the scene; and a display communicating with the processor for displaying the scene. Preferably, the information comprises information suitable for generating the view from a plurality of simulated positions and the simulator further includes an input device for changing the simulated position. Preferably, the information includes information for calculating the view with different fields of view and the simulator further includes an input device for changing the field of view. Preferably, the information includes information for calculating the view in different directions and the simulator further includes an input device for changing the direction of view.

The invention also provides a product that provides black hole flight simulation, the product comprising: instructions for directing a processor to generate electronic signals representing a general relativistically correct scene depicting a visual experience selected from the group consisting of: a view of a black hole from outside the black hole; a view from the inside of a black hole; a view as a black hole is being entered; a view as a black hole is being exited; and a view from a wormhole or white hole or other piece of spacetime that may be attached to a black hole; and a media readable by the processing unit that stores the instructions.

The system further provides a method of simulating a black hole, the method comprising: generating electronic signals representing a general relativistically correct scene depicting a visual experience selected from the group consisting of: a view of a black hole from outside the black hole; a view from the inside of a black hole; a view as a black hole is being entered; a view as a black hole is being exited; and a view from a wormhole or white hole or other piece of spacetime that may be attached to a black hole; directing the signals to a display; and displaying the scene.

The display can be any display now known or known in the future. For example, electronic displays connected to the scene generator either via wired or wireless systems may be used. Projection displays may be used. For example, the scene may be transferred to film and displayed using a projector. The display also may be created by making an animation of the images generated by the method of the invention.

Numerous other features, objects and advantages of the invention will become apparent from the following description when read in conjunction with the accompanying drawings.

### BRIEF DESCRIPTION OF THE DRAWINGS

FIG. 1 is a screenshot showing an image of a black hole silhouetted against the Milky Way;

FIG. 2 is a line drawing illustrating the geometry of FIG. 1 to which a texture is attached;

FIG. 3 is a line drawing illustrating the geometry of the “celestial sphere” to which textures are attached;

FIG. 4 is a screenshot showing the scene from a charged black hole in which the pilot has flown inside the outer and inner horizons of the black hole, and back out through the inner horizon of the white hole, and is currently in the throes of passing out through the white hole;

FIG. 5 is a line drawing illustrating the geometry of FIG. 4 to which textures are attached;

FIG. 6A is an illustration of the three dots that represent the vertices of one triangle of the geometry of an object;

FIG. 6B is an illustration of the three dots that represent the same vertices on the texture;

FIG. 7 is an illustration of the celestial ellipsoid that comes from Lorentz-transforming the geometry depicted in FIG. 3;

FIG. 8 is a flow schematic for the black hole flight simulator; and

FIG. 9 is a flow schematic for creating the layers of scenery.

### DETAILED DESCRIPTION OF THE PREFERRED EMBODIMENT

The Black Hole Flight Simulator (BHFS) is a suite of software designed to simulate interactively the visual experience of flying around, inside, or through, a black hole.

The current (June 2002) version of the BHFS is written in the “C” language. The BHFS falls into essentially two parts, a Relativistic Engine, and a Graphics Engine. In the current implementation, the Graphics Engine is built on SGI's OpenGL Performer API. However, it would not be hard to translate the Graphics Engine into another API, and the BHFS should not be regarded as being tied to one particular graphics API. The important things are, first, the Relativistic Engine, which is completely independent of the Graphics Engine, and second, the logic of the interface between the Relativistic Engine and the Graphics Engine.

The following paragraphs give details of specifications that are important features of the BHFS.

The BHFS is general relativistically correct. The term “correct” here means that the scene is calculated mathematically according to Einstein's General Theory of Relativity.

The BHFS renders full screen at interactive frame rates on current (June 2002) PC-type computers equipped with a fast graphics card. A target interactive frame rate would be 15 frames per second or more, although slower rates are tolerable. The author's computer is a Dell Precision M40 laptop with a 1.2 GHz Pentium III CPU, an Nvidia Quadro2GO graphics card, 512 MB of RAM, and 64 MB of texture memory. On this machine, a simple case, where a black hole lenses a background scene, runs at 30 frames per second on a 1024×768 screen. Sixty frames per second can be achieved if the screen is reduced to 512×512. A more complicated case, where the pilot falls through a black hole on a properly calculated non-radial orbit, runs at 10-20 frames per second, depending on how many “universes” are visible to the pilot at any time. With “everything” turned on, as many as 18 layers of scenery may become simultaneously visible, causing the frame rate to drop as low as 4 frames per second. This “everything turned on” scene is generally not preferred for education purposes, because it tends to be confusing; however, it could be useful for action sequences in movies, etc.

In the simulation according to the invention, the pilot is free at any time to look in any direction, and to change the field of view (zoom in and zoom out), by appropriate operation of an input device such as mouse, keyboard, or joystick. In its current implementation, the BHFS also contains a fisheye option, which allows a 360-degree view of the entire sky.

The scene rendered on the screen may contain both large-scale static scenery and moving objects. In either case, the scene appears to the pilot correctly distorted (gravitationally lensed) and redshifted (shifted in color and brightness) in accordance with general relativity. Large-scale scenery may include background images of our Universe or other universes that the pilot may see or visit, images of the various horizons of the black hole, or images of an accretion disk around the black hole. Moving objects may include such things as asteroids, other spacecraft, or bullets fired by the pilot.

Moving objects in the scene move on correct general relativistic orbits, and they spin correctly in accordance with conservation of spin angular momentum. They appear on the scene correctly positioned, redshifted, sized, and distorted, and with the correct time delay as seen by the pilot, because of the varying light travel time between object and pilot. If desired, moving objects may be permitted to accelerate (as another spacecraft might), or to change their spin. In a rigid object, the vertices of the object remain a fixed proper distance apart in the object's frame of reference. In a flexible object, the vertices of an object move on their geodesics, so that the object tends to be pulled apart by the gravitational tidal force of the black hole.

The pilot may move in a general relativistically correct fashion. In the absence of acceleration, the scene moves, spins, and redshifts as if the pilot were in a spacecraft moving freely in the gravitational field of the black hole. If the pilot accelerates or changes the spin, the scene reacts as if the pilot were maneuvering a real spacecraft. Alternatively, the pilot may suspend realistic motion, and step artificially through space and time.

The BHFS allows the pilot to fly not only around a black hole, but also inside it, and even through it. Where the general relativistic solutions permit, the pilot is allowed to fly through Cauchy horizons and singularities, even though such things might be forbidden in physical reality.

The pilot may change the physical parameters of the black hole. The no-hair theorem states that an isolated black hole is characterized by just three parameters: its mass, its electric charge, and its spin. In its current (June 2002) implementation, the BHFS includes only non-rotating black holes (with zero spin), but it is expected that a future implementation will include rotating black holes. In its current implementation, the BHFS allows arbitrary values of mass and charge, including presently physically unrealistic values (negative mass, imaginary charge, or charge exceeding the mass). For example, a black hole with imaginary charge (i.e., with negative value of the squared charge) contains trajectories in which the pilot passes through the central singularity. A future implementation of the BHFS may incorporate other fixed geometries, such as wormholes threaded with exotic matter (negative mass, essentially) at their throats.

A brief account of the insides of black holes, as depicted in the invention, follows. Stellar-size black holes are thought to form from the core collapse of a massive star, incidentally causing a supernova. So if you want to find a black hole in a stellar system, a good place to look is a system of massive stars. The invention simulates this visual experience in the approach to the black hole. The simplest kind of black hole, a Schwarzschild Black Hole, is non-rotating, and has a mass but no charge. The Schwarzschild black hole has a single horizon, the event horizon, from within which nothing can escape, not even light. A pilot who falls inside a Schwarzschild black hole cannot escape, but is doomed to die at the singularity, a point of infinite curvature at the center of the black hole. Actually, a pilot would already be dead before hitting the central singularity, pulled apart (“spaghettified”) by the enormous tidal force of the black hole. A good way of thinking about a black hole is to imagine that space is falling into it like a river. At the event horizon, the inward flow of space exceeds the speed of light, carrying everything with it.

The next simplest kind of black hole, a Reissner-Nordström Black Hole, is also non-rotating, but it has electric charge as well as mass. In addition to an outer horizon, a charged black hole has an inner horizon, a so-called Cauchy horizon. At the inner horizon, the inward flow of space slows to less than the speed of light. At a certain point inside the inner horizon, but before hitting the singularity, the flow of space actually turns around, and accelerates back outward. As the outward flow accelerates past the speed of light, it defines a second inner Cauchy horizon, the entrance to a white hole. A white hole is effectively a time-reversed black hole. Whereas everything in a black hole necessarily falls inward, everything in a white hole is inevitably thrust outward. The flow of space carries out through the outer horizon of the white hole into another universe. The reason for this strange behavior of a charged black hole is that the charge at the center of the black hole is gravitationally repulsive. The charge is gravitationally repulsive because part of the mass of an electric charge resides in the energy density of the electric field that surrounds it. The pilot is affected gravitationally only by the mass interior to their radius. As the pilot approaches the central charge, the mass interior to the pilot gets less and less, to the point where the interior mass actually becomes negative.

It is this negative mass which is gravitationally repulsive, and causes the flow of space inside the charged black hole to turn around and pass into a white hole. Thus, a pilot who falls into a charged, Reissner-Nordstrom, black hole falls first through an outer horizon, then through an inner horizon, then is accelerated back through an inner horizon into a white hole, and thence out through the outer horizon into a new Universe.

This may not correspond to physical reality, but it is useful for educational purposes. That is, although the above correctly describes the exact general relativistic solution of an empty charged black hole, reality is probably different. Many studies have shown that inner Cauchy horizons are unstable. The physical reason for the instability is that energy, either from outside the black hole or generated by the collapse of the black hole, tends to collect at the Cauchy horizon. The weight of the energy that collects at the Cauchy horizon tends to carry it inward towards the singularity. Thus, in reality, an infaller will probably not pass through a white hole into a new universe, but rather will continue on to the central singularity and death. Exactly what happens remains unknown. In the interests of fun, curiosity, and educational integrity, the BHFS implements the standard Reissner-Nordström solution for charged black holes. It is believed that such true-to-theory simulations will lead to progress in the field, as it will allow the complicated theories to be readily visualized.

The most complicated kind of (isolated) black hole is a Kerr-Newman Black Hole, which has mass, charge, and spin. Whereas real black holes (e.g., those in x-ray binaries or in quasars) are probably only weakly charged, they probably do have (large, typically) spins.

The phenomenology of a spinning black hole is essentially the same whether it has charge or not. A spinning black hole has outer and inner horizons just like a charged non-rotating black hole, and much of the phenomenology is similar. A pilot falling into a spinning black hole will fall through the outer horizon, then through the inner horizon, then will be accelerated out again past inner and outer horizons of a white hole into a new universe. In a spinning black hole, it is the centrifugal force, rather than the effective gravitational repulsion of the charge, that causes the flow of space to turn around inside the black hole and come back out through a white hole. Once again, the Cauchy inner horizons of spinning black holes are unstable to small perturbations, so again probably none of this happens in reality. An infaller will fall to a singularity and die. A spinning black hole contains other features not present in a non-rotating black hole. Notably, there exists “closed time-like loops” at negative radius in a spinning black hole. A closed time-like loop is a loop in time that keeps repeating itself.

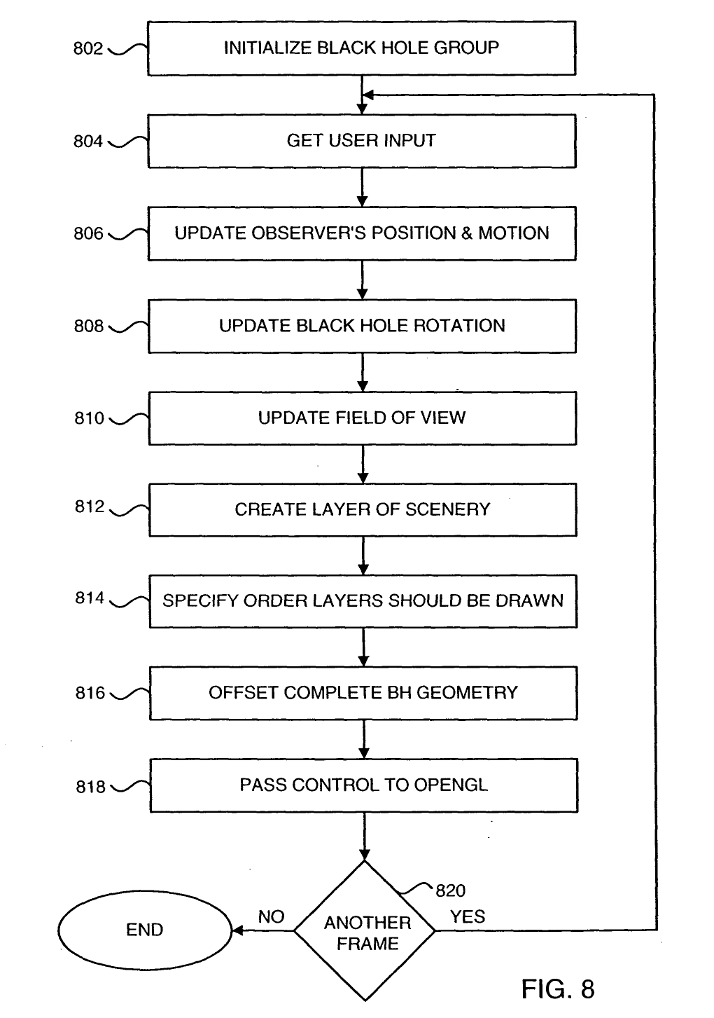

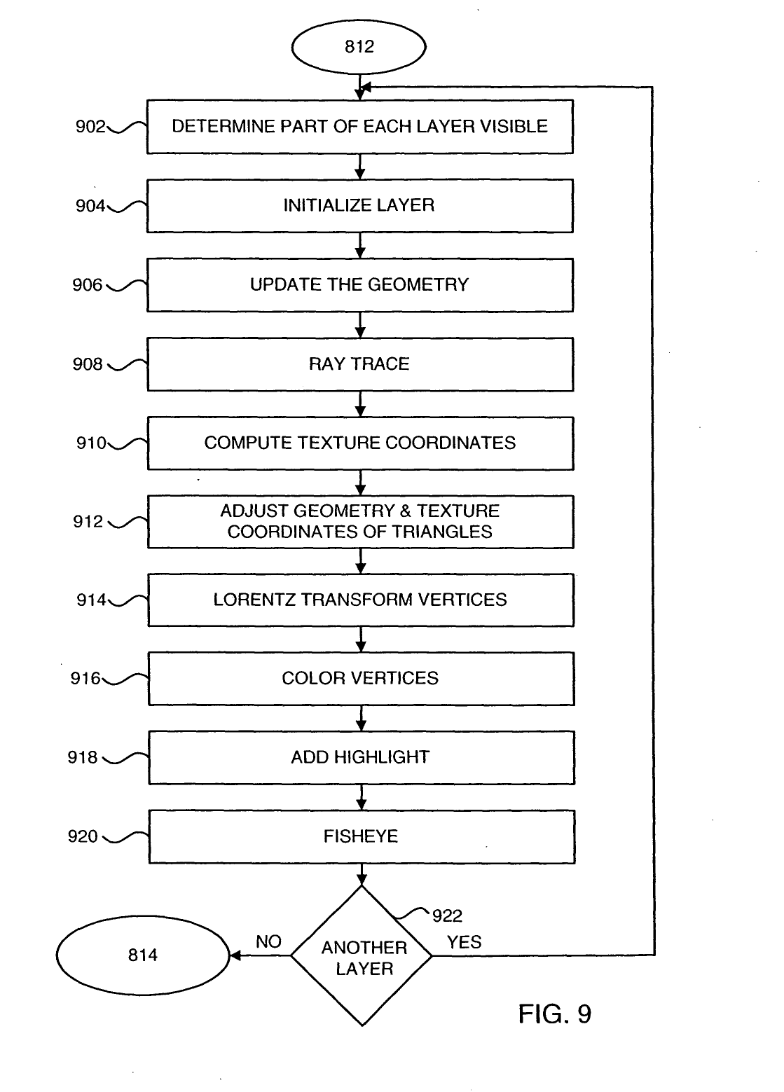

FIGS. 8 and 9 provide a flow schematic according to the invention. The BHFS is designed so that it can live inside the context of a larger program if desired. For example, the BHFS will, in the future, be incorporated into the “Cosmic Atlas”, a software product of the Denver Museum for Nature and Science (DMNS). To facilitate this, the BHFS defines as its top level construct a Black Hole Group 802. A BH Group contains everything pertaining to a single black hole, including the parameters of the black hole, all the geometric structures, textures, etc., associated with the black hole, including white holes, parallel universes, objects falling in the gravitational field of the black hole, and so on.

Although BHFS scenery is painted on an artificial “celestial sphere” surrounding the observer, that celestial sphere need cover only part of the sky in a larger application. With suitable adjustments, the partial sphere containing the black hole and a surrounding region of gravitationally lensed imagery can be blended with undistorted imagery far away from the black hole. Thus, one could, for example, travel through the Galaxy to visit the Black Hole at its center. The Black Hole would become visible only as we approached it.

When a BH Group is created, the BHFS creates placeholders for all the structures associated with the BH. However, memory for the geometry, texture, etc., of any particular layer or component of the BH is not allocated until needed, that is, until the layer or component actually becomes visible on the screen.

Large-scale scenery includes background images of our Universe or of other universes that the pilot may see or encounter. It may also include “heads-up” displays of the various horizons of the black hole, and other large-scale elements of the scene, as described below. Large-scale scenery is implemented using textures, which are OpenGL objects containing graphic images. Textures may be read in from external sources, such as pictures of the Milky Way or other sources. With appropriate hardware, textures may also come from video source. Alternatively, textures may be generated internally by the program. Currently, besides being able to read textures from external sources, the BHFS is able to generate grid textures, and a variety of noise textures. Noise textures may mimic cloud-like or plasma-like gas around or inside the black hole.

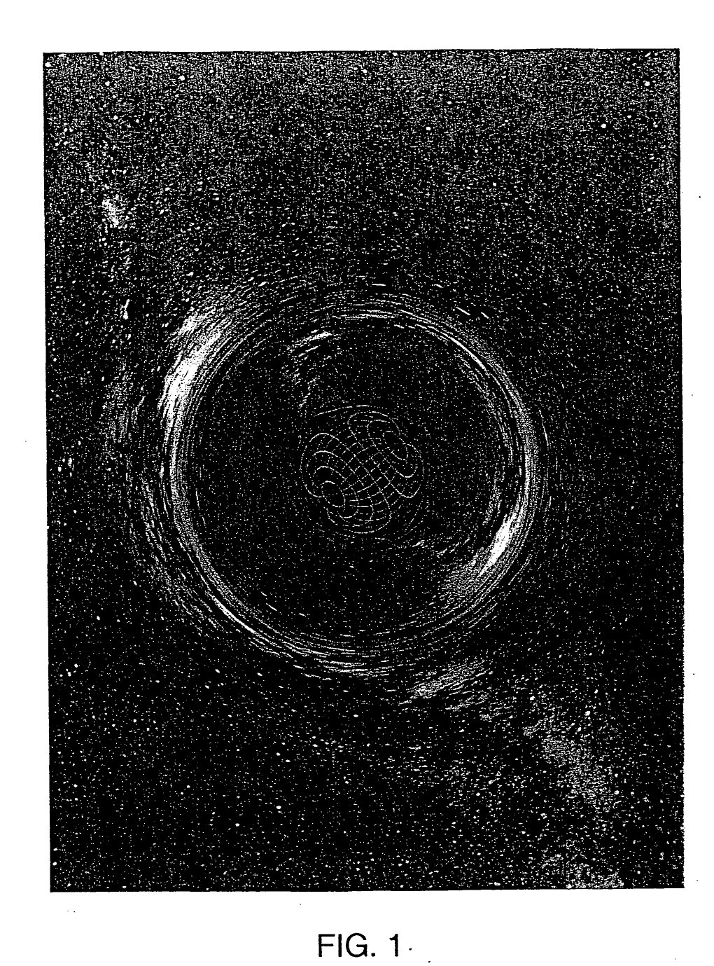

FIG. 1 is a screenshot from the BHFS, showing an image of a black hole silhouetted against the Milky Way. The surface, or event horizon, of the black hole is painted with an internally generated grid texture. A real black hole, of course, would not come equipped with grid lines on its surface. However, one can imagine a set of emitters, located infinitesimally above the event horizon, that transmit their latitude and longitude to the outside world. The grid painted on the event horizon of the black hole in FIG. 1 is what would be reconstructed from the information transmitted by such emitters. As a practical matter, one can imagine that any self-respecting spacecraft visiting a black hole would be equipped with a heads-up display capable of painting an image on the event horizon of a black hole. Black holes are, after all, dangerous things.

It is worth emphasizing that the BHFS can use any texture for large-scale scenery. For example, a photograph of the Grand Canyon for scenery can be used. There can be interesting effects if there is a black hole in the Grand Canyon.

Large-scale scenery: Geometry on the Celestial Sphere. The spatial geometry of a black hole is not generally that of ordinary 3-dimensional Euclidean space. Thus, it is not possible to treat a black hole as a 3-dimensional object in the fashion that OpenGL would normally expect. To solve this problem, the BHFS surrounds the observer with an artificial “celestial sphere”, and paints scenery on the inside surface of this celestial sphere.

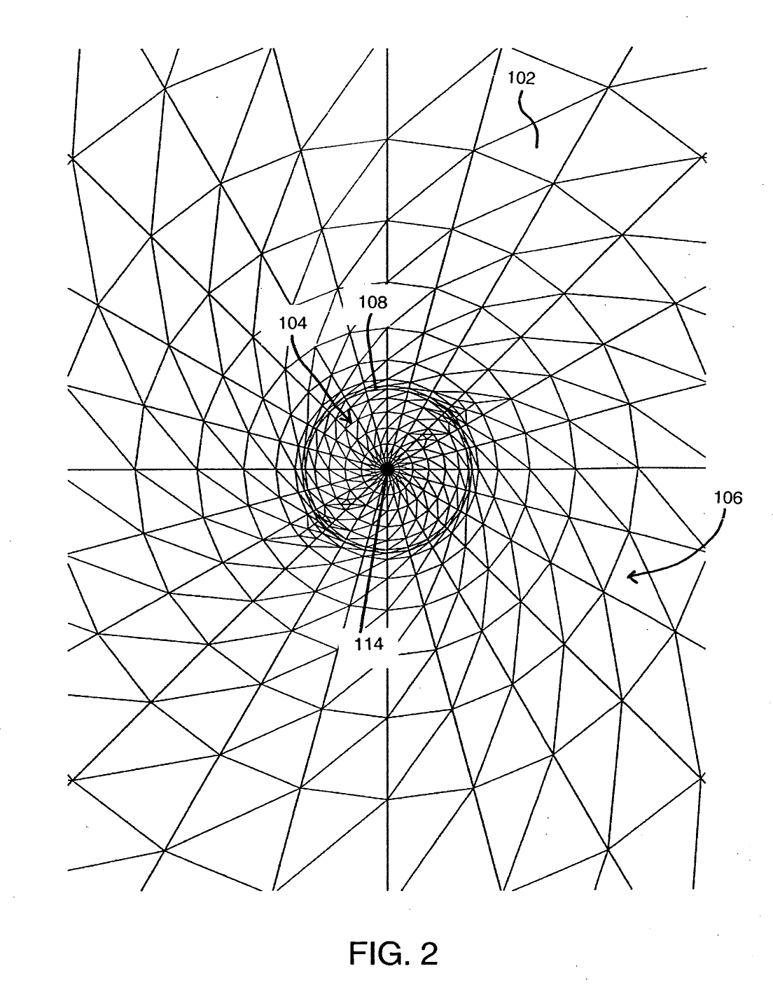

FIG. 2 is a line drawing (actually generated within the BHFS) illustrating the geometry of a close-up or planar view of the celestial sphere to which the image of FIG. 1 is attached.

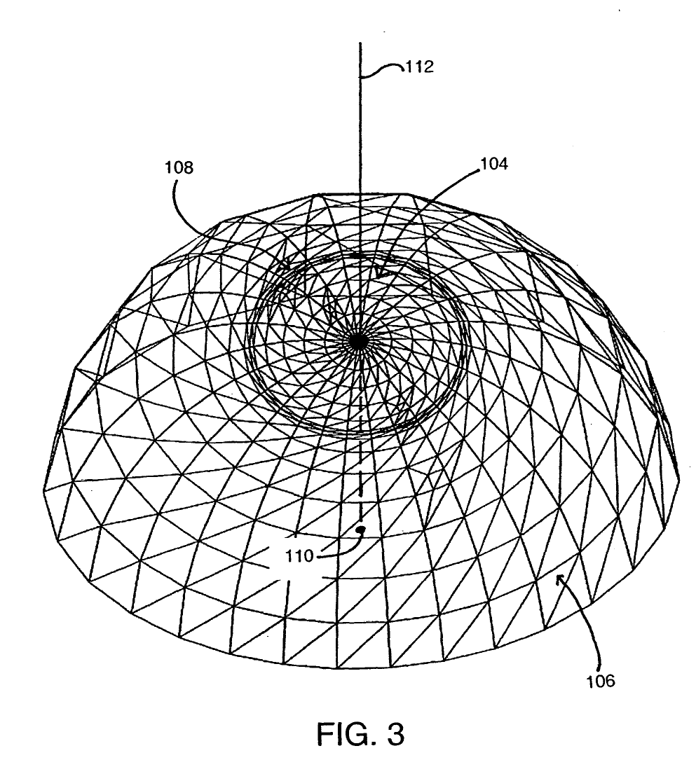

FIG. 3 is a line drawing (actually generated within the BHFS) illustrating the geometry of the “celestial sphere” to which images (textures) are attached. Normally, the pilot would be situated at the center of the celestial sphere, and would be gazing outward at the inside surface of the celestial sphere.

The geometry 906 is updated as follows. The geometry on the celestial sphere is recalculated on the fly as necessary, frame by frame if necessary. If the scene is not moving, and if the field of view is constant, then the geometry is not recalculated. If the scene moves (for example, because the pilot moved), or if the field of view changes, then the geometry is recomputed.

Typically, it is necessary to create geometry not over the entire celestial sphere, but only over that part of the sphere that is visible on the pilot's screen. In some cases, such as 360-degree fisheye mode, the geometry covers the entire celestial sphere.

The geometry on the celestial sphere is not a universal geometry for everything, but rather is built from separate “layers”. For example, FIGS. 2 and 3 shows a geometry with two layers. The first layer forms a disk layer 104 near the top of the celestial sphere. On this layer will be painted an image of the horizon of the black hole. A second layer abuts the central layer, forming a ring layer 106 around it. On this second layer will be painted an image of the background Universe. The result, viewed by the pilot 110 at the center of the celestial sphere, looks similar to FIG. 1.

In the case illustrated in FIGS. 2 and 3, the two layers do not overlap, but in general different layers may overlap. If layers overlap, the foreground layer(s) are usually semi-transparent.

The celestial sphere is triangulated, that is, built up from small triangles 102. The smaller and more numerous the triangles, the better the appearance on the screen. For clarity, the triangulation shown in FIGS. 2 and 3 is fairly coarse. The triangulation used by the BHFS is variable, but in the default setting it has 4 times the linear resolution, i.e., 16 times as many triangles.

As illustrated in FIGS. 2 and 3, the triangulation of each layer is arranged to be squashed (have higher resolution) near the edge of the geometry 108. This is because the edge of the geometry 108 is where gravitational distortions are typically strongest, and where the image is liable to change most rapidly from frame to frame. In the BHFS, the edge squashing has been adjusted empirically to achieve a visually pleasing effect. Some layers, notably those associated with images reflected in the central singularity of the black hole, require enhanced resolution at the centers as well as at their edges. This central squashing is also implemented in the BHFS for layers that need it.

By default, the BHFS attempts to generate geometry with roughly the same number of triangles 102 (on the order of several thousand) on the screen, irrespective of the field of view. In this fashion, it attempts to maintain acceptable image quality whether the field of view is large (e.g., 360 degrees in fisheye mode), or small (say 1 degree). The BHFS takes advantage of a number of accelerations designed to reduce the CPU time spent computing geometries of layers.

First, as already stated above, the BHFS computes geometries only for layers that are (partially) visible to the pilot, and it computes geometry only for those parts of layers that are visible or nearly visible to the pilot. Second, the BHFS constructs geometries in a fashion that takes advantage of the spherical symmetry of non-rotating black holes. In FIGS. 2 and 3, for example, both the disk layer 104 (the horizon of the black hole) and the surrounding ring layer 106 (the background Universe) have rotational symmetry about an axis joining the center of the black hole to the pilot. The vertices of the triangulation of the geometry may be specified by coordinates (r, phi) relative to the axis of symmetry 112. For example, the geometry of the disk layer 104 (the horizon) illustrated in FIG. 3 has 9 discrete values of the radial coordinate r, and 24 discrete values of the angular coordinate phi, for a total of 8×24+1=193 vertices (the central vertex, at r=0, requires only one angular coordinate phi). The BHFS pre-computes the 9 values of the radial coordinate r, and the sines and cosines of the 24 values of the angular coordinate phi, and uses these pre-computed values to accelerate computation of the coordinates of the actual vertices located on the celestial sphere.

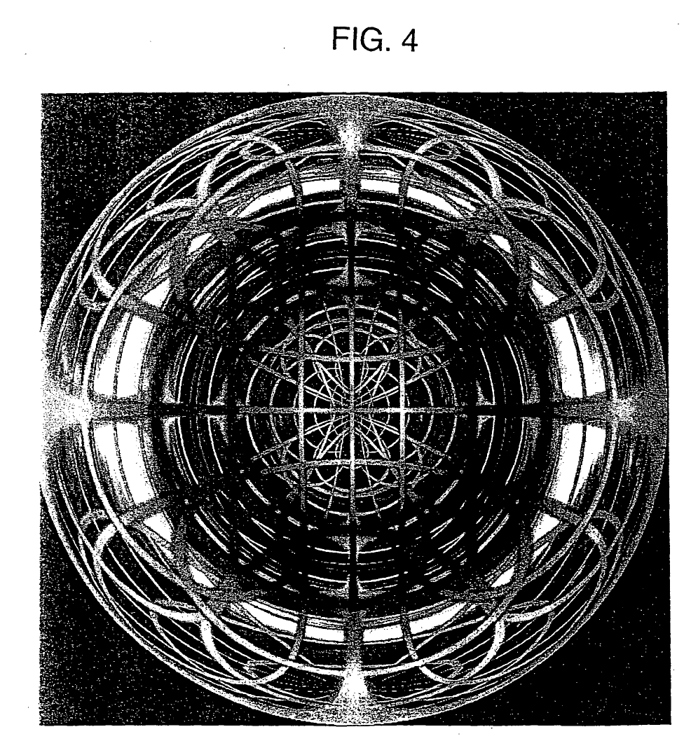

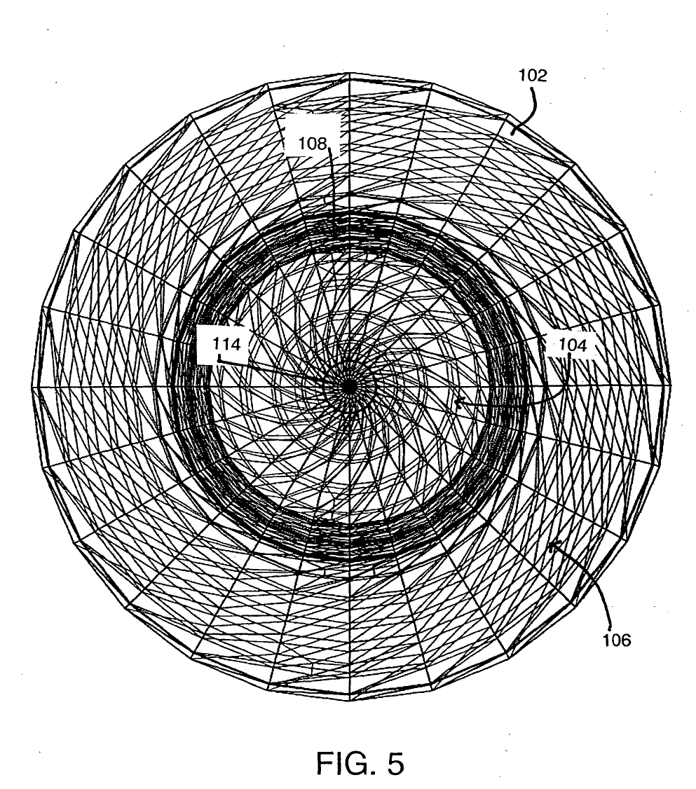

Turning now to the large-scale scenery, i.e., layers 812, the large-scale scene may be built from several separate overlapping layers. For example, FIG. 4 is a screenshot from the BHFS, showing the scene from a charged black hole in which the pilot has flown inside the outer and inner horizons of the black hole, and back out through the inner horizon of the white hole, and is currently in the throes of passing out through the white hole. FIG. 4 resembles art, but it is science. FIG. 4 is a fisheye view looking back towards the center of the black hole, as the pilot flies through the white hole. Our Universe is visible at the center of the image, reflected by the singularity. Behind us (at the outer edge of the fisheye image) is an image of a “parallel universe”, a universe connected to the interior of the black hole via a wormhole (the Einstein-Rosen bridge). We can never travel to this “parallel universe”, but we can see light, which has fallen from the parallel universe into the black hole. FIG. 4 shows in addition several grids, which mark the location of the three horizons, one outer and two inner, that we have passed through. FIG. 5 is a line drawing (actually generated within the BHFS) illustrating the geometry of FIG. 4 to which images (textures) are attached.

The BHFS does not use OpenGL's z-buffering (depth buffering), but rather draws layers in a prescribed order, from back to front. Altogether, FIG. 4 is built from ten layers, of which eight, the horizon layers, are semi-transparent. In its current implementation, the BHFS identifies seventy-two separate layers, listed in the include file “mangle.h”. Only some subset of these layers is visible at any point. Of the seventy-two layers, twenty are associated with “universes” of one kind or another. They have names like “Our Universe”, “Our Universe Reflected”, “New Universe”, “Parallel Universe”, and “Antiverse”. In the current BHFS, the largest number of universes simultaneously visible to a pilot falling through a black hole is four, which happens in the case of a black hole with imaginary electric charge. A further twenty-six layers are associated with horizons of various kinds. Eighteen layers are generically called “Planet”, and are associated with a sphere of arbitrary radius (a planet, conceivably) concentric with the black hole. For example, a neutron star is not a black hole, but is sufficiently compressed that general relativistic distortions of its surface and surroundings are visible. A “Planet” layer can show what the neutron star would look like.

The final six layers are generically called “River”, a name that came from the original intention of illustrating the flow of space like a “river” into a black hole. A “River” layer is not actually a single layer, but consists of several spherical sublayers. In effect, a “River” layer is a fully three-dimensional object. For example, one could paint an accretion disk, perhaps computed separately, onto the surfaces of a “River”. In many cases, the same physical object must be drawn in several layers. For example, a semi-transparent “Planet” in a universe with no black hole is drawn in two layers, the far side first, then the near side.

A final two layers are called “flare”, which produce the visual effect of a bright flare when passing through the inner Cauchy horizon, where the viewer is supposedly subject to an infinitely bright flash of energy.

Turning now to the process 902 of deciding what is visible in large scale scenery. The BHFS only draws layers that are visible to the pilot. The first step in the decision process is set by the pilot, who decides what subset of layers (s)he would like to see. Each of the seventy-two layers are tagged with an identity, and can be turned on and off individually. More usually, the BHFS keeps track of where the pilot has been, and turns layers on and off appropriately. There are hot keys to toggle on/off various groups of layers, such as horizons, or parallel universes, or flares. Given the possible subset of layers to be drawn, the BHFS decides what is visible based, first, on the field of view, and second, what is the angular extent of each layer on the celestial sphere.

For non-rotating black holes, the spherical symmetry of the black hole means that the visible extent of a layer has axial symmetry about the axis 112 joining the pilot 110 and the center of the black hole 114. Thus, a layer may have an inner angular boundary, and an outer angular boundary, forming a ring on the celestial sphere about the black hole. In some cases, the inner boundary may shrink to nothing, so that the ring becomes a disk centered on the black hole; in other cases, the outer boundary may shrink to nothing, so that the ring becomes a disk centered on the point antipodal to the black hole on the celestial sphere.

It turns out that computing the angular extent of a layer, the minimum and maximum angles at which it can be seen relative to the black hole center, is not that hard. For example, a boundary in many cases is defined by the photon sphere, the photons on which have a certain definite angular momentum, and the direction of which is therefore easy to compute.

Complexity arises not because the calculation is hard, but because there are a large number of cases to consider. In the current version, the BHFS contains 72 layers of scenery. Each layer may be viewed by pilots at various different radii: outside the photon sphere, outside the outer horizon, outside the inner horizon, outside what might be called the inner photon sphere, where photons from the outer photon sphere turn around and go back out, outside the turnaround radius, and inside the turnaround radius. Each case must be dealt with individually. This takes 10943 lines of code in the “mangle.c” program, and is one of the most exhausting things to program.

A further subtlety arises because, to avoid seams appearing where two layers abut, it proves necessary to ensure that the angular boundaries of two abutting layers are computed numerically exactly the same. While getting two layers to match seamlessly may sound simple enough, getting 72 layers seen from all possible vantage points to match is not trivial.

Turning now to the process 908 of ray-tracing for large scale scenery, an essential feature of the BHFS is the ability to accomplish fast, general relativistically correct ray-tracing over the whole scene. As with the geometry, the BHFS ray-traces on the fly as necessary, frame by frame if necessary. Generally, it is necessary to redo a ray-trace only if the geometry changes.

The geometry on the celestial sphere is recalculated on the fly as necessary, frame by frame if necessary. If the scene is not moving, and if the field of view is constant, then the geometry is not recalculated. If the scene moves (for example, because the pilot moved), or if the field of view changes, then the geometry is recomputed.

The BHFS achieves this using “textures”, which are OpenGL objects containing graphic images. A fundamental feature of modern 3D graphics cards is the ability to paint textures on to geometry as fast as possible. One measure of the performance of a 3D graphics card is how many millions of triangles per second it can paint. With a graphics card, a modern PC-type computer might be able to paint a scene at say 30 frames per second. Without a graphics card, the same machine might render the same scene at only one frame per second.

The computation of the coordinates of textures operates as follows. Each triangle 102 of the geometry of an object has three vertices, specified by a set of three (x,y,z) coordinates. Associated with these three vertices is a set of three texture coordinates. Textures can be one, two, or three-dimensional, but typically a texture is a two-dimensional image, in which case each texture coordinate is specified by two numbers (s,t) each varying from 0 to 1.

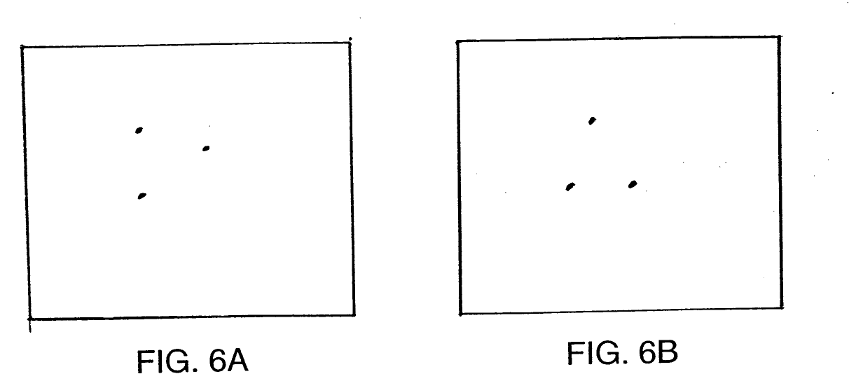

This situation is illustrated by the line drawing of FIGS. 6A and 6B. In FIG. 6A, the three dots represent the vertices of one triangle of the geometry of an object, as it might appear on the screen. In FIG. 6B, on the right, the three dots represent the same vertices on the texture. The (x,y,z) coordinates in FIG. 6A can be specified arbitrarily; and the (s,t) texture coordinates on the right can be specified arbitrarily. It is the job of the code-writer to specify to OpenGL both the geometrical coordinates and the texture coordinates of each of the triangles of any object. OpenGL will then feed these coordinates to the graphics hardware, which will fill triangles in the way it knows best.

The strategy adopted in the BHFS is to specify the geometry of the scene as described earlier, and to compute where each vertex of the geometry maps onto the texture. This strategy is equivalent to ray tracing from the pilot's eye backward to the source, rather than forward from the source to the pilot's eye. Backward ray tracing strategy is much faster than forward ray tracing because, whereas every ray starting from the eye is guaranteed to hit the background image at some point, not all rays starting from the background image are guaranteed to hit the eye of the pilot.

Ray tracing by direct integration along paths around and through a black hole can be both computationally expensive and “difficult”. For example, the apparent edge of a black hole, as seen by a pilot, is defined by the photon sphere, where a photon can orbit a black hole potentially an infinite number of times. Following photons along such orbits can be tricky. Similarly, one would like to be able to trace light rays reliably through the singularity of a black hole (as happens in the case of black holes with imaginary charge).

Fortunately, as is well known, trajectories of orbits in all the standard black hole solutions (Schwarzschild, Reissner-Nordström, Kerr-Newman) are equipped with a full set of integrals of motion, namely the mass per unit energy, the angular momentum per unit energy, the magnitude of the 4-momentum per unit energy, and, in the Kerr-Newman case, the so-called Carter integral. Thanks to these integrals of motion, it is possible to reduce the solution of orbits to quadratures. In all cases, the quadratures turn out to be elliptic integrals.

The strategy in the BHFS is to ray-trace scenery analytically, using integrals of motion and the solution of elliptic integrals. Elliptic integrals are integrals whose integrands are rational functions multiplied by the square root of a quartic polynomial. The BHFS evaluates elliptical integrals using the fast numerical algorithms published by Carlson et al.: Zill D G & Carlson B C (1970) Symmetric Elliptic Integrals of the Third Kind, Mathematics of Computation 24, 199; Carlson B C (1977) Elliptic Integrals of the First Kind, Siam Journal On Mathematical Analysis 8, 231-242; Carlson B C (1979) Computing Elliptic Integrals by Duplication, Numerische Mathematik 33, 1-16; Carlson B C (1987) A Table of Elliptic Integrals of the Second Kind, Mathematics of Computation 49, 595-606; Carlson B C (1987) Supplement to A Table of Elliptic Integrals of the Second Kind, Mathematics of Computation 49, S13-S17; Carlson B C (1988) A Table of Elliptic Integrals of the Third Kind, Mathematics of Computation 51, 267-280; Carlson B C (1988) Supplement to A Table of Elliptic Integrals of the Third Kind, Mathematics of Computation 51, S1-S5; Carlson B C (1989) A Table of Elliptic Integrals: Cubic Cases, Mathematics of Computation 53, 327-333; Carlson B C (1991) A Table of Elliptic Integrals: One Quadratic Factor, Mathematics of Computation 56, 267-280; Carlson B C (1992) A Table of Elliptic Integrals: Two Quadratic Factors, Mathematics of Computation 59, 165-180.

Before evaluating an elliptical integral, it is first necessary to find the roots of the quartic polynomial whose square root appears in the integrand. The BHFS finds quartic roots (which may be real or in complex conjugate pairs) analytically using the Ferrari method. The Ferrari method involves finding a real root of a certain associated cubic polynomial. In some cases, the root of the cubic is given in terms of differences of large numbers and is not accurately determined numerically. The BHFS stabilizes the cubic root by plugging it back into the equation it is supposed to satisfy, and correcting the root if necessary. The overall algorithm for finding the roots of a quartic proves to be robust and fast under all circumstances encountered in the BHFS.

The BHFS further accelerates the ray tracing by taking advantage of the spherical symmetry of non-rotating black holes. The spherical symmetry means that there is axial symmetry in the distortion of images about an axis joining the pilot and the center of the black hole. For example, the geometry of the central disk-like layer of the geometry illustrated in FIGS. 2 and 3 is defined by vertices with 9 discrete values of the radial coordinate r, and 24 discrete values of the angular coordinate phi. Thanks to axial symmetry, the amount that a light ray bends around the black hole depends only on r, not on the angular coordinate phi. Thus, it is necessary to ray-trace only once for each of the 9 values of r.

Scenery at different radii from the black hole must be ray-traced separately. Background universes, for example, are at nominally infinite radius from the black hole, while the outer and inner horizons are some finite radii that depend on the mass and charge of the black hole. “Planet” and “River” layers are at whatever radii the pilot puts them.

A by-product of ray-tracing is the redshift factor of each vertex, defined to be the ratio of the photon energy perceived by the pilot to the photon energy that would be perceived by a stationary observer infinitely far from the black hole.

Ray-tracing thus yields two acceleration arrays for each layer: an angle for how far a light ray perceived to come from a given direction has orbited about the black hole; and a redshift factor. To accelerate matters further, the BHFS pre-computes the sine and cosine of the orbital angle, which are needed to compute the texture coordinates associated with each vertex of the geometry.

Large-scale scenery: Texture Coordinates 910. At this point, the geometry of each layer of scenery has been constructed, and the ray tracing has been completed. The next task is to generate texture coordinates. Deriving texture coordinates from the ray-traced geometry is a straightforward matter of elementary trigonometry.

The reason for isolating the derivation of texture coordinates as a separate step is that it is possible for the texture to change while the geometry and ray tracing remain unchanged. For example, it is possible to orbit the black hole at constant radius with the black hole remaining always at the same place in the scene. Here, the geometry and ray tracing remain the same from frame to frame, and only the texture changes, giving the appearance of a black hole rotating against a rotating background. In accordance with the usual strategy of the BHFS, texture coordinates are recomputed on the fly only as necessary. Because the texture coordinate for each vertex must be computed one by one, this step can take a comparable amount of CPU as the ray-tracing step, even though it is much simpler.

Turning now to the process 912 of making adjustments to the geometry and texture coordinates for large scale scenery, the textures used for large-scale scenery in the BHFS typically cover the entire sky. For example, Axel Mellinger's Milky Way texture used in FIG. 1 to represent “Our Universe” covers the entire sky. This leads to two difficulties, both associated with the edges of allsky textures. The first difficulty occurs at the left and right edges of an allsky texture, which should wrap around and abut each other. The second difficulty occurs at the top and bottom edges, which represent the north and south poles of the allsky texture. OpenGL does not deal with these problems automatically.

To ensure a correct wraparound at the left and right edges of an allsky texture, the BHFS goes through every triangle of the geometry to test whether or not the triangle straddles the edge. If the triangle does straddle the edge, then the triangle is excised from the geometry, and replaced by a new triangle with its own texture coordinates. For example, if the horizontal coordinates of the 3 vertices of a triangle are 0.99, 0.01, and 0.03, then the BHFS will make the educated guess that the triangle straddles the edge, and replaces the triangle with a new triangle with horizontal coordinates 0.99, 1.01, and 1.03. This causes OpenGL to fill the triangle correctly.

The top and bottom edges of an allsky texture, representing the north and south poles, produce a different problem, visible in scenery as streaking and rippling in the vicinity of poles. The streaking effect is caused by mipmap texture filtering attempting to cope with the extremely different effective horizontal and vertical resolutions near a pole of an allsky texture. The solution, which is not necessarily ideal, is to turn off mipmap filtering in OpenGL. The rippling effect is caused by the fact that it is impossible to arrange the vertices of a triangle that encompasses a pole so that the triangle is filled correctly from an allsky texture. To reduce this problem, the BHFS identifies triangles that encompass poles, and subdivides them to achieve higher resolution. This usually improves the visual appearance of scenery at poles.

Although the adjustments to edge and pole triangles affect only a small fraction of the triangles of a geometry, identifying the triangles and carrying out the required adjustments takes a comparable amount of CPU time to other stages of the pipeline, such as setting up the geometry, and doing the ray tracing. The BHFS contains options to turn on or off the edge and pole adjustments. Generally, the edge adjustment should always be turned on. The pole adjustment can be either on or off; some scenes look better with pole adjustment on, others look better with it off.

Turning now the process 914 of determining Large-scale scenery: Lorentz transformations for large scale scenery, pilots moving around and inside black holes inevitably find themselves moving at a large fraction of the speed of light relative to the scenery. Under such circumstances, the scene appears relativistically “beamed” and red- or blue-shifted. This is a purely special relativistic effect: even in the absence of black holes, a pilot moving through scenery at near the speed of light will see the scene in the forward direction concentrated, blue-shifted, and brightened, while the scene behind is expanded, red-shifted, and dimmed. The effect is similar to a bicyclist peddling through a rainstorm. Even if the rain is coming vertically downward, the rain appears to the cyclist to come from ahead, and to be fiercer in the forward direction than behind.

The first thing to do is to define a canonical frame of reference, a standard state of motion of the pilot. In fact, the discussion of scenery so far has assumed, without explicitly mentioning it, some canonical frame of reference. The standard frame of reference adopted in the BHFS is that of a pilot who free falls radially towards the black hole from zero velocity at infinity. This differs from the frame of reference often assumed in discussions in textbooks, where the observer is taken to be at rest relative to distant stars. Unfortunately, the stationary frame cannot be adopted as the canonical frame, because there are no stationary frames inside the outer horizon (technically, between the inner and outer horizons). The radially free-falling frame is the simplest and most natural one. There is a similar natural set of frames for rotating black holes, associated with observers who free-fall from zero velocity at infinity, although these orbits are not really purely radial.

On white hole branches, the standard frame of reference is similarly that of a pilot who free falls radially outward to zero velocity at infinity. Some locations, for example inside the turnaround radius of a charged black hole, cannot be reached by observers who free fall inward from, or outward to, zero velocity at infinity. In this case, the canonical frame of reference reverts to the stationary frame, where the pilot is at rest relative to distant fixed stars.

Both relativistic beaming and the red/blueshift a re described by a Lorentz transformation. A Lorentz transformation depends on the direction of motion of the observer relative to the canonical frame, and the Lorentz transformation possesses axially symmetry about this direction. In principle, one might exploit this axial symmetry to accelerate the Lorentz transform, but the BHFS does not do this, because the BHFS has already used up the freedom of setting up geometry with axial symmetry on the axial symmetry about the axis between pilot and black hole. Instead, the BHFS Lorentz transforms each coordinate separately, using a fast method described below to maintain high speed.

It turns out that Lorentz transforming a scene is equivalent to distorting the celestial sphere into a celestial ellipsoid, stretching the sphere in the direction of motion by the Lorentz gamma factor, and placing the pilot at one of the foci of the ellipsoid. The faster the pilot moves, the longer the ellipsoid becomes. If the radius of the original celestial sphere is one, then the red/blueshift factor at any point on the celestial ellipsoid is equal to the distance between the point and the pilot at the focus. This is in effect how the BHFS does Lorentz transforms: by distorting the celestial sphere into an ellipsoid.

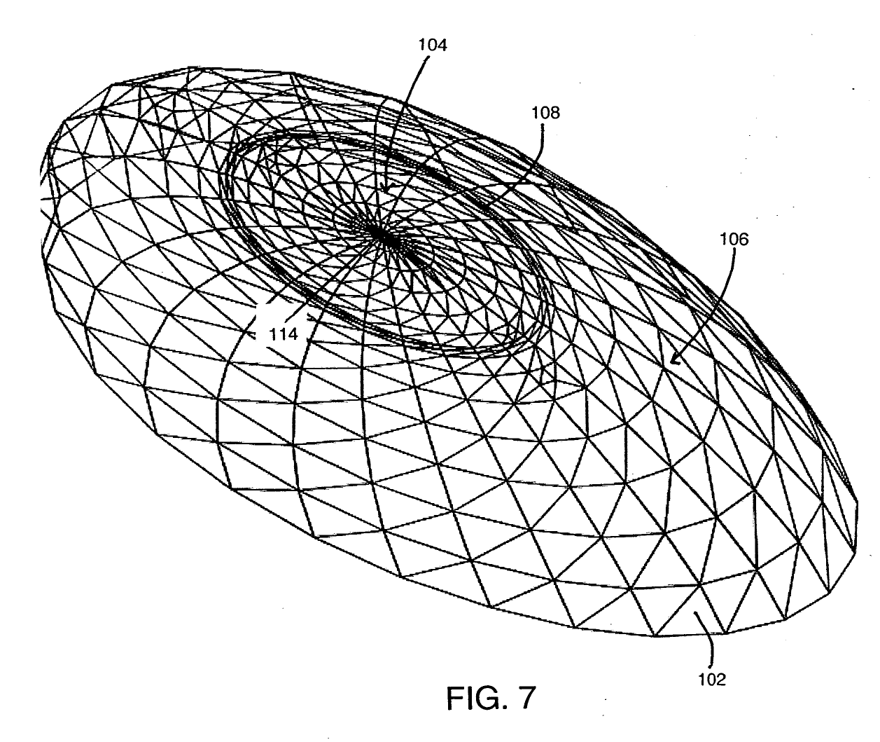

FIG. 7 illustrates the celestial ellipsoid that comes from Lorentz-transforming the geometry shown in FIG. 3. The BHFS does Lorentz transforms on the fly as necessary, frame by frame if necessary. If the pilot is not moving relative to the canonical frame of reference, then no Lorentz transform is necessary. Again, if the geometry and the state of motion are unchanged between frames, then it is not necessary to re-Lorentz-transform the scene.

Since it may be necessary to Lorentz transform frame by frame, and since each vertex is transformed separately, it is advantageous to use a fast method to do Lorentz transforms. BHFS does Lorentz transforms using complex quaternions. A quaternion is a kind of hypercomplex number, of the form a+ib+jc+kd, where i, j, k are all anti-commuting imaginary numbers, satisfying i\hat{ }2=j\hat{ }2=k\hat{ }2=−1 and ijk=1. A complex quaternion is a quaternion a+ib+jc+kd in which each of the coefficients itself is a complex number, for example a=a_R+I a_I, where I is yet another imaginary number, I\hat{ }2=−1, which commutes with all the other imaginaries i, j, k.

It is a well-known fact that the fastest way of programming ordinary 3-dimensional rotations is with real quaternions. Programs such as Tomb Raider exploit this fact. Lorentz transformations generalize 3-dimensional rotations to include 4-dimensional rotations between space and time. It turns out that Lorentz transformations map to complex quaternions in a similar way. The group of Lorentz transformations contains ordinary 3-dimensional rotations as a subgroup. In quaternionic language, the 3-dimensional rotation subgroup inside the group of complex quaternions is just the subgroup of real quaternions.

The description of Lorentz transformations in terms of complex quaternions is simple, general, concise, fast, and most definitely mathematically elegant. Simple: the composition of two Lorentz transformations is the quaternionic product of the two corresponding complex quaternions. The description is general in that the group of complex quaternions is, in fact, isomorphic to the covering group of Lorentz transformations, so one can actually transform not only vectors, but also spinors, which are spin-1/2 objects. Furthermore, bivector objects such as the electromagnetic field are transformed with the same economy as vectors. The description is concise in that Lorentz transformations are encoded as an 8-component object, a complex quaternion, instead of as a 16-component 4×4 matrix. The description is fast in that the Lorentz transformation involves only additions and multiplications, no trigonometric functions (no sin, cos, sin h, or cos h). Actually, the initial step of converting a rotation or boost to a Lorentz transformation does involve trig functions; but subsequent Lorentz transformations of coordinates, which are the important thing for the BHFS, require no trig. The description is smooth in that complex quaternions provide an elegant, physically motivated way to interpolate between Lorentz transformations.

As a further acceleration, it turns out that it is possible to encapsulate two 4-vectors in a single complex quaternion, and therefore to do two Lorentz transforms at once, effectively doubling the speed of the operation. The first 3 components of each 4-vector determine the direction of the coordinate, while the 4th component determines the red/blueshift factor.

The process 916 of generating colors for large scale scenery is as follows. The ray tracing and Lorentz transformation described above yield two red/blueshift factors at each point of the geometry. These two factors multiply together to produce a net red/blueshift factor at each point. To apply the red/blueshift in a physically correct way, it would be necessary to know information about the complete electromagnetic spectrum of the scene being viewed. Redshift means that the spectrum is shifted redward, so that, for example, ultraviolet wavelengths may become visible optically. Similarly, blueshift means that spectrum shifts blueward, so that infrared wavelengths may become visible to the eye. Redshifts and blueshifts around or inside black holes may become extreme, requiring information about spectra beyond ultraviolet or infrared.

Usually, this kind of wavelength information is not available. If it were, it might be possible to maintain high frame rates by encoding the information in three-dimensional textures, with the third dimension representing wavelength. In the meantime, the BHFS implements red/blueshifts in a simplistic fashion by coloring each vertex of the geometry with a blackbody color at an appropriately red/blueshifted temperature. OpenGL allows a color to be associated with each vertex of the geometry. As the graphics hardware fills each triangle with an image from the texture, it shades that image with color interpolated from the vertices of the triangle. Although this shading of textures is not physically correct, it should not cause confusion to the user, who naturally assumes that dim red shading means that the scene is redshifted, while blue shading indicates a blueshift.

Since the computation of blackbody colors takes a little time, the BHFS pre-computes a look-up table of blackbody RGB values at 256 logarithmically-spaced values of temperature. A color at any temperature is taken to be the color of the nearest temperature in the table. By default, the BHFS adopts a temperature of 4096 Kelvin as the nominal temperature of an object with redshift factor one (i.e., neither redshifted nor blueshifted). The corresponding color is a pleasing off-white rust color. The no-redshift color can be changed if desired. Blackbody colors have a huge range of brightness, which a computer monitor cannot possibly match. The BHFS clamps the brightness of each blackbody color between minimum and maximum values. These values are also adjustable. The BHFS takes some care to construct blackbody colors correctly.

By convention of the Commission Internationale de l'Éclairage (CIE), colors are defined by their “tristimulus” coordinates X, Y, Z. The fact that there are three coordinates reflects the fact that the eye contains three kinds of cones, sensitive respectively to long (red), medium (green), and short (blue) wavelengths. The X, Y, Z coordinates are linear measures of light power, so that the coordinates of any sum of colors is the sum of the coordinates of the colors. The X, Y, Z coordinates of monochromatic colors every 5 nanometers are defined by a 1931 convention adopted by the CIE. The X, Y, Z coordinates of a blackbody color at a given temperature can be obtained by integrating the monochromatic X, Y, Z over the spectrum of a blackbody (the Planck spectrum).

To convert X, Y, Z coordinates of a color to the R, G, B coordinates used by computers, it is necessary to specify the colors of the R, G, B guns of the computer's screen. While the properties of actual computer screens may differ quite a bit, it is usual to assume a standard set of values, notably those recommended in Rec. 709 (ITU-R Recommendation BT. 709, 1990, “Basic Parameter Values for the HDTV Standard for the Studio and for International Programme Exchange, formerly CCIR Rec. 709). By default, the BHFS assumes Rec. 709 values for the colors of R, G, B guns, although it is straightforward to change those values if desired. Defining the X, Y, Z colors of the R, G, B guns defines a 3×3 matrix, which converts X, Y, Z to R, G, B.

Often the resulting R, G, B values will lie outside the “gamut” of colors that a computer screen can produce. You know when this happens because one or two (never three) of R, G, B may be negative. The standard solution to this is to desaturate the color by adding white, equal parts of R, G, B, so that all three values are greater than or equal to zero. Computer screens (or television screens) cannot produce colors quite as deep and vivid as reality, but most people don't notice this.

At this point, the R, G, B values are linear measures of color. However, the eye does not respond linearly to light. The usual way of dealing with this is to apply a “gamma-correction” to the linear R, G, B values, a roughly power-law function which produces nonlinear R, G, B values which are perceptually more uniformly spaced. By default, the BHFS applies the gamma-correction recommended by Rec. 709. Again, it is straightforward to modify the gamma-correction if desired.

The process 918 of generating highlights for large scale scenery is as follows. Unfortunately, while it is possible to make a texture darker by folding it with a color, in OpenGL it is impossible to make the texture brighter, because OpenGL refuses to accept color factors greater than one. In the BHFS, one would very much like to brighten regions, which are highly blue-shifted. Indeed, if one passes through the Cauchy horizon of a black hole, then there is a spot, which is infinitely blueshifted, which ought to be experienced as a blinding flash of light.

In principle, it might be possible to work around this problem using three-dimensional textures. However, the BHFS adopts a more simplistic solution, which is to add a specular highlight in regions where the blueshift factor becomes large (by default, greater than two). In OpenGL, specular highlights represent reflections of light sources off surfaces. A specular highlight is defined by placing a light source somewhere, defining normal vectors on the surface of the reflecting geometry, and defining the specular properties of the reflecting material.

The BHFS brightens regions of high blueshift with a white (actually almost imperceptibly violet) specular highlight. This is done by reverse engineering. An artificial and otherwise invisible light source is placed at the position of the observer, the pilot. Normal vectors at each vertex of the geometry are then adjusted to point in just such a way as to produce the desired amount of brightening.

The process 920 of generating a fisheye mode for large scale scenery is as follows. It is often convenient for a pilot to be able to see what is going on behind as well as in front. To accommodate this, the BHFS offers a fisheye mode, which allows the pilot all round vision, at the expense of fisheye distortion. The BHFS accomplishes a fisheye view by shifting coordinates on the celestial sphere away from the anti-center and towards the center of the pilot's field of view.

If the view is 360 degrees, then the triangle, which would normally lie at the antipodes of the pilot's field of view, can potentially become visible from the backside, and block the view. Fortunately, OpenGL offers a solution to this problem, which is that triangles should be visible only from one side. OpenGL decides which side of a triangle is which according to whether the vertices increase clockwise or anti-clockwise. Thus, in the BHFS, triangles of the scenery are all constructed consistently clockwise, and triangles are declared to be visible only from the clockwise side. The net effect of all this hard work is that triangles seen from the wrong side in fisheye mode do not block the view.

A final thing to be done before passing scenery to the graphics hardware is to decide 814 in which order layers should be drawn. This is not terribly hard: usually it is not difficult to decide that such and such layer lies in front of some other layer. For example, the far side of a semi-transparent “Planet” should obviously be drawn first, then the near side.

Usually, the order of drawing remains the same from frame to frame, but it may change in some cases. For example, if the radius of a “Planet” passes through a horizon of the black hole, then the order of drawing the “Planet” and horizon changes. The BHFS changes the order of drawing only when necessary.

As a convenience and a debugging tool, BHFS has a large scale scenery option 816 to offset the pilot away from the normal position at the center of the celestial sphere. This allows the pilot to see directly the geometry that is really being passed to OpenGL. For example, what might normally appear on the screen to be a rotating planet would be seen for what it really is, an optical illusion painted on the surface of a celestial sphere. Aristotle was right after all! This offset mode has already been used in FIGS. 3 and 7 to illustrate the “true” geometry of scenery in the BHFS. The offset is done using a DCS matrix attached to the entire Black Hole group.

The process 806 of movement Moving in the gravitational field of the Black Hole is as follows. The BHFS allows a pilot to move consistently in the gravitational field of the Black Hole, as if the pilot were in a spacecraft. The pilot may move on any permissible orbit, radial or otherwise. In the absence of acceleration, the pilot moves on a geodesic according to the equations of general relativity, and the scene changes, Lorentz transforms, and red/blueshifts accordingly. Frames go by at a rate determined by the proper time experienced by the pilot.

The pilot may choose to point the spacecraft in any direction, and to spin the spacecraft in any way, but if the pilot lets the spin alone, then the spin will evolve correctly, according to the equations of general relativity, so as to conserve spin angular momentum. Alternatively, the pilot may choose to tether the view so that it always points towards the black hole. If the pilot accelerates, then the acceleration is interpreted as though the pilot were firing rockets so as to accelerate in the direction that the spacecraft is pointing.

By default, the mass of the black hole is set approximately equal to the mass of the black hole at the center of the Milky Way, about 2.5 million solar masses. This has the desirable feature that things happen at a sensible rate in real time. For example, it takes twenty seconds of proper time to fall from the horizon to the singularity of a 2.5 million solar mass black hole.

Unlike ray-tracing scenery, it is not necessary to take extraordinary effort to accelerate the solution of the orbital equations for a single pilot. The BHFS integrates the geodesic equations for the radius, angular position, and spin orientation of the pilot using a simple 2nd order Runge-Kutta scheme. The BHFS uses changes of variables to regularize motion through turning points and through the singularity, if the latter occurs (as it can if the charge is imaginary).

If the pilot passes through a turnaround point inside the inner horizon, then the BHFS automatically and seamlessly transfers the pilot from the black hole (infalling) solution to the white hole (outgoing) solution.

If the pilot exits the white hole and then approaches the white hole to fall in, the white hole spontaneously evolves into a black hole. Again, the BHFS automatically and seamlessly transfers the pilot from the white hole to black hole solution.

The BHFS allows the pilot to suspend normal motion, and to step through space and time using arrow keys, mouse, etc. The pilot can apply a Lorentz transform by pointing in any direction and pressing an acceleration key. The pilot can warp between black hole and white hole solutions.

The motion of moving objects is treated in essentially the same way as the motion of the pilot. Each moving object evolves correctly along a geodesic, and its spin evolves so as to conserve spin angular momentum. The motion of pilot and of moving objects is governed by the same equations. The BHFS uses the same 2nd order integration scheme to integrate the equations.

A small but important difference between the treatment of the motion of the pilot versus that of moving objects is that the BHFS evolves the motion of small-scale objects as seen by the pilot, not as experienced by the object itself. The pilot sees the time registered by the object to be slowed down or speeded up relative to the pilot's own proper time. The object thus moves on its orbit in a manner that appears slowed down or speeded up. The difference in clock rate on the object versus the pilot is given precisely by the red/blueshift factor. The difference in clock rates can become extreme. For example, when an object falls through the event horizon of a black hole, its redshift tends to infinity, and its clock appears to a pilot outside the horizon to freeze to a halt.

A prominent example of small-scale objects is a bullet. Bullets are fired by the pilot by pointing in a certain direction and pressing a firing button. The orbit of the bullet is determined by the firing direction, and by the firing velocity, which may be varied.

There has been described a black hole flight simulator that simulates interactively the visual experience of flying around, inside, or through a black hole. It should be understood that the particular embodiments shown in the drawings and described within this specification are for purposes of example and should not be construed to limit the invention, which will be described in the claims below. Further, it is evident that those skilled in the art may now make numerous uses and modifications of the specific embodiments described, without departing from the inventive concepts. Consequently, the invention is to be construed as embracing each and every novel feature and novel combination of features present in and/or possessed by the invention herein described.

We claim:

1. A black hole flight simulator comprising:
a memory for storing information for generating a relativistically correct scene depicting a visual experience selected from the group consisting of: a view of a black hole from outside the black hole; a view from the inside of a black hole; a view as a black hole is being entered; a view as a black hole is being exited; and a view from a wormhole or white hole or other piece of spacetime that may be attached to a black hole;
a processor communicating with said memory for generating electronic signals representing said scene; and
a display communicating with said processor for displaying said scene.

2. A black hole flight simulator in as in claim 1 wherein said information comprises information suitable for generating said view from a plurality of simulated positions and said simulator further includes an input device for changing said simulated position.

3. A black hole flight simulator as in claim 1 wherein said information includes information for calculating said view with different fields of view and said simulator further includes an input device for changing said field of view.

4. A black hole flight simulator as in claim 1 wherein said information includes information for calculating said view in different directions and said simulator further includes an input device for changing said direction of view.

5. A product that provides black hole flight simulator, said product comprising:
instructions for directing a processor to generate electronic signals representing a relativistically correct scene depicting a visual experience selected from the group consisting of: a view of a black hole from outside the black hole; a view from the inside of a black hole; a view as a black hole is being entered; a view as a black hole is being exited; and a view from a wormhole or white hole or other piece of spacetime that may be attached to a black hole; and
a media readable by said processing unit that stores said instructions.

6. A method of stimulating a black hole, said method comprising:
generating electronic signals representing a relativistically correct scene depicting a visual experience selected from the group consisting of: a view of a black hole from outside the black hole; a view from the inside of a black hole; a view as a black hole is being entered; a view as a black hole is being exited; and a view from a wormhole or white hole or other piece of spacetime that may be attached to a black hole;
directing said signals to a display; and
displaying said scene.

7. A method as in claim 6 wherein said directing comprises transferring said scene to a film and projecting said scene utilizing said film to create said display of said scene.

8. A method as in claim 7 wherein said transferring comprises an animation process.

9. A method as in claim 6 wherein said directing comprises utilizing either a wired or wireless connection.
